(19) United States
(12) Patent Application Publication
(10) Pub. No.: US 2008/0060911 A1
(43) Pub. Date: Mar. 13, 2008

(54) Method for operating an aircraft baggage conveyor system

(76) Inventor: Frank Konig, Essen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/900,339

(22) Filed: Sep. 11, 2007

(30) Foreign Application Priority Data
Sep. 12, 2006 (DE) 10 2006 042 733.5

(51) Int. Cl. B65G 47/10; G06F 17/00

(52) U.S. Cl. 198/358; 700/226

(57) ABSTRACT

The invention relates to a method for operating an aircraft baggage conveyor system having containers which are provided for holding and for transporting pieces of baggage and which can be moved successively through the system on individually controllable conveyor sections. In order to prevent stop signals which are implemented too early or too late from leading to faults in the system as a result of cycle time tolerances and in order to permit the containers t6 be stopped in the system in the correct position and without delay using simple means, it is proposed that the stop signal for stopping the container be fed directly to a relay by means of which the drive of the conveyor section which is occupied by the container to be stopped is switched off immediately.

### CROSS REFERENCE TO RELATED APPLICATIONS

This application claims the benefits of German application No. 10 2006 042 733.5 filed Sep. 12, 2006, and is incorporated by reference herein in its entirety.

### FIELD OF INVENTION

The invention relates to a method for operating an aircraft baggage conveyor system having containers which are provided for holding and for transporting pieces of baggage and which can be moved successively through the system on individually controllable conveyor sections of container paths, wherein initiators are provided with which the containers can be sensed and by means of which a stop signal for stopping and/or a start signal for starting the containers can be initiated at a specified stopping point in the system.

### BACKGROUND OF THE INVENTION

In aircraft baggage conveyor systems, containers (baggage holding trays) are used to convey the baggage within the airport. These containers hold a wide variety of aircraft baggage in a safe and protected fashion. The necessary and specified sequences within the aircraft baggage conveyor system require that the containers be capable of being stopped at a wide variety of stopping points in a reproducible fashion. It may be necessary to stop the containers, for example, before devices for tilting the containers or for unloading the aircraft baggage from the containers, but also before vertical conveyors for lifting up the containers onto other transportation levels. In all cases, very precise positioning of the containers is a precondition for the fault-free transfer to the following conveyor unit.

At present, the correct positioning of the containers is ensured using photoelectric barriers. When a container is detected, these photoelectric barriers send a signal to the stored program controller (SPS) just before the provided stopping point is reached, in order to initiate the stopping of the container. However, it has proven disadvantageous here that the reaction time (cycle time), i.e. the time until the stop signal which is transmitted to the stored program controller is carried out, frequently varies so that the containers miss the desired stopping point.

In this context it is not only possible for the containers to travel past the planned stopping point but they can even come to a standstill before the stopping point if the signal is transmitted too quickly to the stored program controller. Since the actual transmission speed of the signal to the stored program controller cannot be predicted or planned, both variants which are due to what is referred to as cycle time tolerance are unsatisfactory in terms of their result. In the most unfavorable case, multiple assignments can occur on the cycle belts which rule out fault-free operation of the system and lead to a situation in which the throughput rates which the operator has been promised cannot be reached. It is also possible for considerable disruption to occur in the region of transfer points where, for example, the transfer to a conveyor device which carries on is intended to take place after the container has been stopped and oriented in a precisely positioned fashion.

### SUMMARY OF INVENTION

The object of the present invention is therefore to find an economical solution which is easy to implement and which permits the containers to be stopped in the required reproducible fashion without delay and correctly positioned in the system, and which ensures that the stopped containers are started likewise without delay and in a reproducible fashion in order to be transported on in the system.

### DETAILED DESCRIPTION OF INVENTION

In order to achieve the object it is proposed that the stop signal for stopping the container be fed directly to a relay by means of which the drive of the conveyor section which is occupied by the container to be stopped is switched off immediately. Precisely positioned stopping is possible because the stop signal is not fed to the stored program controller as before but rather directly to the relay which switches off the drive of the conveyor section immediately. The cycle time tolerances until the stop signal is implemented by the stored program controller, which tolerances had previously led to faults in the system, are avoided.

According to a further feature of the invention it is proposed that, in parallel with the stop signal, an occupation signal is output to the stored program controller (SPS) of the system as a message that a container is present at the stopping point. A nondamaging timing offset of the transmission of the stop signal and of the occupation signal is tolerable because the container has already stopped. The signal to the stored program controller does not serve to position the container but rather functions merely as an occupation signal, for which reason signaling with offset timing is nondamaging. The object of the stored program controller is now, without influencing the stopping point, to check, for example, at which waiting point the container is located and which steps are to be consequently initiated.

The relay is reset in order to stop the conveyor section preferably within a time period between 50 and 30 ms after the stop signal has been output. After the relay has been reset and the container has been checked, the stored program controller (SPS) sets an enable output for the container so that the container is ready to be transported on.

If after the container has stopped it is moved on at the correct time (for example synchronized with a tilting machine), according to another feature of the invention it is proposed that the previously reset relay is activated by an initiator in synchronism with a conveyor section of the system which carries on, and said relay receives a signal for the delay-free switching on of the conveyor section which is occupied by the container. The relay can receive here the signal from a proximity switch or a magnetic sensor, for example.

The conveyor section with the container can thus be activated immediately and without being influenced by cycle time tolerances in order to transfer the container to a further conveyor section, for example a tilting machine or a lifting machine. The invention thus achieves complete decoupling of the starting and stopping processes and the associated cycle time tolerances.

Finally, if, according to another feature of the invention, the initiator is provided on the conveyor section which carries on and if said initiator communicates with a sensor on the container and transmits a completion message to the stored program controller in parallel with the signal to the relay, during the starting process the starting is also decoupled from the signals which are controlled by the stored program controller.

As a result of the abovementioned procedure, the containers can be stopped and started in a reproducible fashion within a baggage conveyor system with minimum, i.e. tolerable, deviations from the stopping point which forms the basis for fault-free running of the system. It thus becomes possible to position the container with the necessary accuracy of +/−30 mm. This accuracy is sufficient, for example, to position a container before a tilting device or a lifting device so that the container can be transferred from the tilting device or the lifting device precisely in accordance with the timing system. As a result, much more reliable and precise control of the system is achieved, specifically with very simple means.

1-6. (canceled)

7. A method for operating an aircraft baggage conveyor system, comprising:
holding and transporting pieces of baggage via containers that move successively through the system on individually controllable conveyor sections of container paths;
initiating a stop signal for stopping and/or a start signal for starting the containers at specified stopping points in the system via initiators that sense the containers; and
transmitting the stop signal directly to a relay via the drive of the conveyor section which is occupied by the container to be stopped is switched off immediately.

8. The method for operating an aircraft baggage conveyor system as claimed in claim 7, wherein an occupation signal in parallel with the stop signal is output to the stored program controller of the system as a message that a container is present at the stopping point, wherein a non-damaging timing offset between the transmission of the stop signal and that of the occupation signal is tolerable.

9. The method for operating an aircraft baggage conveyor system as claimed in claim 8, wherein the relay is reset, within a time period between 50 and 30 ms after the stop signal has been output, in order to stop the conveyor section.

10. The method for operating an aircraft baggage conveyor system as claimed in claim 9, wherein the stored program controller sets an enable output for the container after the relay has been reset and the container has been checked.

11. The method for operating an aircraft baggage conveyor system as claimed in claim 10, wherein the reset relay is activated by an initiator and receives a signal for the delay-free switching on of the conveyor section occupied by the container in order to start a stopped container in synchronism with a conveyor section of the system that carries on.

12. The method for operating an aircraft baggage conveyor system as claimed in claim 11, wherein the initiator is provided on the conveyor section which carries on, and the initiator communicates with a sensor on the container and transmits a completion message to the stored program controller in parallel with the signal to the relay.
